(19) United States
(12) Patent Application Publication
(10) Pub. No.: US 2006/0011712 A1
(43) Pub. Date: Jan. 19, 2006

(54) IMPROVED DECAL SOLDER TRANSFER METHOD

(75) Inventor: Stefano S. Oggioni, Milano (IT)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/160,887

(22) Filed: Jul. 14, 2005

(30) Foreign Application Priority Data
Jul. 15, 2004 (FR) 04368052.9

(51) Int. Cl. B23K 31/02; B23K 35/12

(52) U.S. Cl. 228/254; 228/180.22; 228/253

(57) ABSTRACT

A method is provided for forming alloy deposits at selected areas on a receiving substrate, including providing a decal alloy carrier, having alloy loadable areas in selected positions thereof, the alloy loadable areas being adapted to being loaded with an alloy mass, mating the decal alloy carrier with the receiving substrate, so that the alloy loadable areas substantially correspond to the selected areas on the receiving substrate, and reflowing the solder alloy masses so as to cause transfer of the alloy from the alloy loadable areas to selected areas on the receiving substrate, such as solder-affine pads, while ensuring that the decal alloy carrier and the receiving substrate are kept in close contact one to another at least during the reflowing. The alloy loadable areas are preferrably recesses in the decal alloy carrier having flat bottoms, which results in relaxed alignment tolerances.

### TECHNICAL FIELD

The present invention relates generally to the field of semiconductor technology, more specifically to Integrated Circuit (IC) and/or Micro-ElectroMechanical-Systems (MEMS) or Micro-OptoElectroMechanical-Systems (MOEMS) manufacturing and, particularly, to the aspects relating to electrical and/or mechanical interconnection of the IC/ MEMS and/or MOEMs chips to each other and to the external world. More specifically, the invention concerns an improved method for the transfer of solder alloys that are used for accomplishing the desired electrical and/or mechanical interconnections.

### BACKGROUND ART

In the field of IC and MEMS or MOEMS manufacturing, interconnect technology plays an important role, and in the years has experienced an evolution in consequence of the trend towards miniaturization and increased integration scale.

The definition of interconnection is primarily intended for the electrical characteristics of the interconnections, but there are involved also important aspects for the interconnection that are purely mechanical in nature.

Although interconnections can be realized in a number of other ways, the liquid-metal bonding, i.e. soldering is considered the favorite approach for many applications. According to this technique, a deposit of solder alloy, i.e. a solder alloy mass (a so-called solder bump or dome) is provided at selected areas (interconnection pad areas) of, e.g., an IC chip. The solder domes are then used for bonding to the pads e.g. bonding leads of a package.

Several methods are known for providing the solder domes at the interconnection pads; for example, the solder dome may be formed by depositing the solder alloy gradually through evaporation or electroplating, or by means of liquid solder transfer processes, or exploiting solid solder transfer processes.

One technique known in the art for forming the solder domes at the desired pad areas is the so-called “decal” solder transfer: a pattern of solder alloy is firstly formed on a substrate (the decal substrate) made of a material that is not wettable by (i.e., it has no metallurgical affinity with) the solder. The solder pattern on the decal substrate matches the corresponding pattern of pad areas of a receiving substrate (e.g., an IC chip) where the solder deposits have to be provided, and is for this reason referred to as a solder decal. Then, the solder decal is mated with the target IC chip, having care to properly align the latter with the decal, so that the solder pattern on the decal matches the corresponding pad areas of the target IC chip. The solder is then made to reflow or reliquify by heating, thereby the solder wets the desired pad areas. The decal substrate separates from the melted alloy by its nature of not being compatible to form metallurgical bonds with it, or it can be separated away, e.g. lifted, from the IC chip while the solder is still liquid, so that the solder remains attached to the pad areas. Finally the solder is cooled down so as to metallurgically bond it to the pads. Such a technique is described for example in U.S. Pat. No. 5,673,846.

The decal solder transfer technique has proved to be effective especially in those cases where there is the need of transferring small amounts of solder alloy, such as, for example, when Area Array Packages (AAPs) are to be used.

The Applicant has however observed that the conventional way of implementing the decal solder transfer is affected by some problems, mainly related to the spatial shape of the solder domes that are obtained.

In fact, the mass of solder alloy that remains attached to the pad when the decal substrate is separated, for example lifted from the target IC chip, is roughly spherical.

The Applicant has observed that this may pose serious problems during the subsequent phase of bonding, e.g., package leads exploiting the solder alloy deposits, or, as another example, when two or more IC and/or MEMS/MOEMS chips are to be interconnected in a stacked-up arrangement, and the physical dimensions of the areas of interconnection (solder joints) are small, being in the micron or even sub-micron range. This is for example the case when stacks of MEMS and/or MOEMS chips are to be realized.

Having roughly spherical solder domes, or, generally, solder domes with rounded, curved surfaces makes the alignment of two chips to be interconnected to each other a rather difficult task. The placement tolerance is in fact determined by the degree of overlap between, on the one hand, the solder dome provided on the first chip, and, on the other hand, the metal pad of the second chip to be stacked up on the first one. Having a solder dome with a rounded, e.g. roughly spherical surface strongly reduces the area offered by the solder dome to the pad to be mated thereto; ideally, if the solder dome were a perfect sphere, such an area would reduce to a geometric point.

U.S. Pat. No. 6,656,750 describes, in connection with a method for testing IC chips, a method according to which a planarization process of electroplated solder balls is conducted, so as to increase the target area to be probed. In particular, a flat platen with a flat planar surface is pressed onto the top surfaces of the solder balls which, being formed by electroplating, are soft enough to have their top surfaces flattened by the platen.

The Applicant observes that such a technique, consisting substantially in mechanically re-shaping the roughly spherical solder domes when the solder is in the solid phase (technique which could be referred to as “coining”, due to the similarities with the traditional process of coining coins exploiting a hammer-like tool hitting the surface of the mass to be flattened) may be unsuitable in some cases, particularly when the dimensions of the solder alloy deposits are of the order of few microns of thickness, and it is not possible to apply a hammering force in a controlled way. Surely, brutal techniques like this are not at all suitable when MEMS/MOEMS chips are involved. In fact, MEMS/MOEMS typically include tiny, very fragile mechanical structures, e.g. cantilevers, rotating units, etc., of micron and sub-micron dimensions, which would be most probably destroyed by the process of coining.

### SUMMARY OF THE INVENTION

Accordingly, the Applicant has faced the problems evidenced by the state of the art outlined in the foregoing.

According to an aspect of the present invention, there is provided a decal solder transfer method of forming alloy deposits at selected areas on a receiving substrate, comprising:
providing a decal alloy carrier, having alloy loadable areas in selected positions thereof, said alloy loadable areas being adapted to being loaded with an alloy mass;
mating said decal alloy carrier with the receiving substrate, so that said alloy loadable areas substantially correspond to the selected areas on the receiving substrate; and
reflowing the alloy masses so as to cause transfer of the alloy from said alloy loadable areas to the selected areas on the receiving substrate, while ensuring that said decal alloy carrier and the receiving substrate are kept in close contact one to another at least during said reflowing. Selected areas of the receiving substrate are preferably alloy-affine (i.e. wettable by the alloy) areas such as interconnection pads, while the decal alloy carrier is preferably comprised of a material chosen not to bond metallurgically to the alloy.

According to another aspect of the invention, the method further comprises resolidification of the alloy after said reflowing, wherein said resolidification of the alloy is performed while ensuring that said decal alloy carrier and the receiving substrate are kept in close contact one to another.

According to yet another aspect of the present invention, a method of interconnecting a first substrate to a second substrate is provided, including forming transferred alloy deposits at selected areas on the first substrate, and using the transferred alloy deposits, bonding the second substrate to the first substrate at selected areas on the second substrate, said selected areas on the second substrate having metallurgical affinity with the transferred alloy deposits, wherein said forming transferred alloy deposits comprises:
providing a decal alloy carrier, having alloy loadable areas in selected positions thereof, said alloy loadable areas being adapted to being loaded with an alloy mass;
mating said decal alloy carrier with the first substrate, so that said alloy loadable areas substantially correspond to the selected areas on the first substrate; and
reflowing the alloy masses so as to cause transfer of the alloy from said alloy loadable areas to the selected areas on the first substrate, while ensuring that said decal alloy carrier and the first substrate are kept in close contact one to another at least during said reflowing.

According to another aspect of the invention, second alloy deposits may be transferred to the second substrate, which may then be used to bond to the first alloy deposits on the first substrate.

### BRIEF DESCRIPTION OF THE DRAWINGS

The features and the advantages of the present invention will be made apparent by the following detailed description of an embodiment thereof, provided merely by way of non-limitative example, description that will be conducted making reference to the attached drawings, wherein:

FIG. 1 schematically shows, in top-plan view, and with a portion shown in enlarged scale, a wafer intended to be used as a decal solder alloy carrier in a decal solder transfer method according to an embodiment of the present invention;

FIG. 2 schematically shows a cross-sectional view of the decal wafer along line II-II of FIG. 1;

FIG. 3 shows, in a schematic way similar to FIG. 1, a substrate onto which the solder alloy is intended to be transferred, for example a wafer of MEMS chips;

FIGS. 4A to 4E schematically show, in cross-sectional views, some of the phases of a decal solder transfer method according to an embodiment of the present invention;

FIGS. 5A and 5B schematically show two phases of a process of die stacking and bonding exploiting solder alloy transferred using a method according to an embodiment of the present invention; and

FIGS. 6A and 6B schematically show exemplary geometries of the solder alloy deposits that allow relaxing the placement tolerances in e.g. a chip stacking and bonding process.

### DETAILED DESCRIPTION OF THE PREFERRED EMBODIMENT(s)

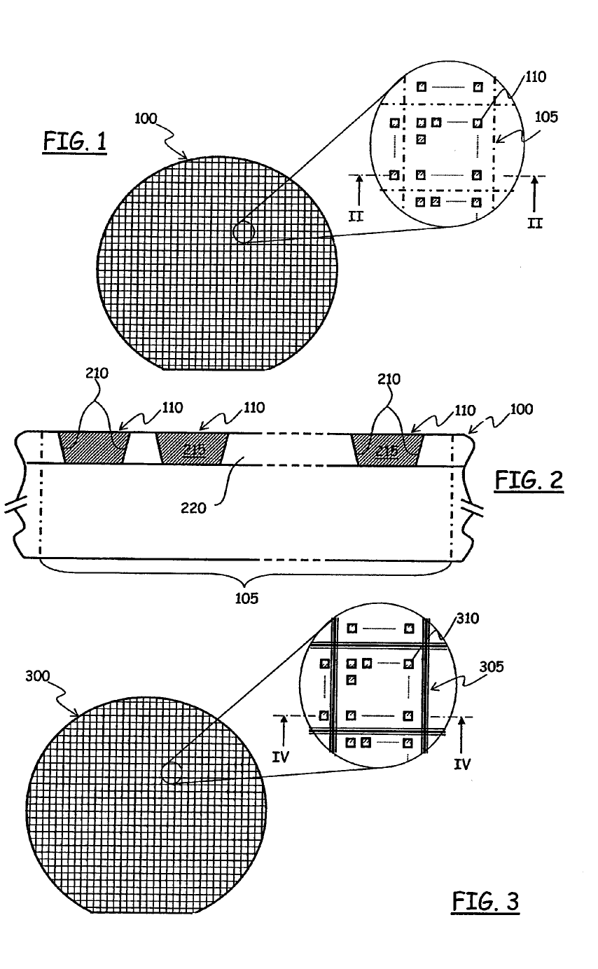

With reference to the drawings, FIG. 1 schematically shows, in top-plan view, and with a portion shown in enlarged scale, a decal solder alloy carrier adapted to the use in a decal solder transfer method according to an embodiment of the present invention.

The decal solder alloy carrier, globally identified by 100, is made of a material that is non-wettable by the solder alloys typically used in the field of semiconductor technology, i.e. a material that has no metallurgical affinity with, and thus does not metallurgically bond to the solder alloy. In particular, according to a preferred embodiment of the invention, the decal solder alloy carrier 100 is in a material that has a relatively low thermal expansion coefficient, particularly a thermal expansion coefficient sufficiently lower compared to that of a target substrate onto which the solder alloy is intended to be transferred. Suitable materials for the decal solder alloy carrier 100 include for example silicon, glass, quartz, and like materials or composition of materials.

In an embodiment of the present invention, perse not limitative, the decal solder alloy carrier 100 is in the form of a wafer (hereinafter referred to as decal wafer 100), particularly of shape and size matching those of a wafer of material forming the target substrate on which there are formed the chips (e.g., IC chips, MEMS chips, MOEMS chips, and the like) that are intended to receive the solder alloy. The decal wafer 100 is (at least ideally) subdivided into a plurality of portions, each one located in a position of the decal wafer 100 corresponding to the position wherein there is located a chip in the target wafer onto which the solder alloy has to be transferred. In the enlarged-scale partial view of the decal wafer 100 depicted in FIG. 1, one such decal wafer portion 105 is visible, delimited by dash-and-dot lines.

Within the decal wafer portion 105, one or, typically, more than one solder alloy carrying areas 110 are provided, particularly, as shown in the schematic cross-sectional view of FIG. 2, in the form of solder alloy fillable pockets 210, each one adapted to be filled with a solder alloy mass 215.

In particular, the pockets 210 may be formed in the decal wafer 100 by means of conventional photolithographic techniques, of the type used for manufacturing semiconductor IC chips, MEMS chips, MOEMS chips and the like. For example, the decal wafer 100 may have a superficial layer 220 of a selectively etchable material, within which the pockets 210 are excavated using masked etching processes.

The decal wafer 100 can for example be produced by wet or dry etch bulk micromachining, which is a batch parallel process based on the same fabrication processes used in the production of ICs (in the art, bulk micromachining is the preferred method to create structures in pure monilithic silicon wafers). As a result of this process, the removal of silicon or other materials like quartz, germanium, gallium arsenide, glass and silicon carbide is made possible. In wet etch processes the result is dependent on the crystal orientation of the substrate and which variety of anisotropic etchant is used in conjunction with different etch stops, for example potassium hydroxide (KOH), tetramethyl ammonium hydroxide (TMAH), ethylene diamine pyrocathecol (EDP). The etch rates of silicon substrates changes according to the orientation of the crystals within the silicon. Faster etch rates are achieved with (100) crystal orientation, while the slowest etch rate is with (111) crystal orientation. Dry etch systems include the use of vapor and plasma etchants.

Another possible way for fabricating the decal wafer 100 is by exploiting the technique known as surface micromachining, which is a process that creates cavities or structures on the surface of the silicon substrate by applying layers of sacrificial and non-sacrificial materials. The sacrificial material layers, typically SiO₂, are then etched by means of hydrofluoric acid, leaving the desired polysilicon structure behind. This process can also use polymeric, i.e. Benzo Cyclo Butene (BCB) or other materials like waxes to temporarily mask and protect selected areas from the etchants. The solder alloy carrying areas 110 of the decal wafer 100 may be loaded with solder alloy by filling in the pockets 210 with solder alloy. A suitable process that can be exploited to fill the pockets 210 with solder alloy is for example the so-called Injection Molded Soldering (IMS), described for example in U.S. Pat. No. 5,244,143 and U.S. Pat. No. 5,673,846, the relevant teachings of both of which documents being incorporated herein by reference. In very general terms, IMS provides for injecting liquid solder alloy into the pockets 210 formed in the decal wafer 100, and then cooling the solder down, or letting the solder cool down, so that the solder alloy solidifies within the pockets 210, resulting in the solid solder alloy masses 215. Due to the fact that the material of the decal wafer is chosen so as not to have affinity with the solder, the latter does not metallurgically bond to the decal wafer 100.

Once the decal wafer 100 has been loaded with solder alloy, in the selected areas 110, it is ready to be used as a decal substrate for transferring the solder alloy onto an intended solder alloy receiving substrate. As pictorially shown in FIG. 3, the solder alloy receiving substrate may for example be a wafer 300, of shape and size corresponding to those of the decal wafer 100, and in turn subdivided into a plurality of portions 305, each one forming e.g. an IC and/or MEMS or a MOEMS chip (in the enlarged-scale partial view of the wafer 300 depicted in FIG. 3, one such chip 305 is visible, delimited by lines that are for example scribe lanes along which the chip 305 will be separated from the other chips of the wafer, by means of a scribing process).

The generic chip 305 of the wafer 300 includes one or, typically, more than one selected receiving areas, such as interconnection pads 310; the pads 310 are for example electrical interconnection pads, to which there are connected electrical lines (not shown) of the IC or MEMS/MOEMS chip 305; the interconnection pads 310 may also include pads that are not intended for electrical interconnection of the IC or MEMS/MOEMS chip to the external environment or to each other, but merely for mechanical connection purposes, with, e.g., another chip, for example in a stacked-chip arrangement. In general, the receiving areas, such as interconnection pads 310, are exposed areas of a material capable of being wetted by the solder alloy (i.e. being solder-affine areas), such as aluminum, copper, gold, palladium and the like.

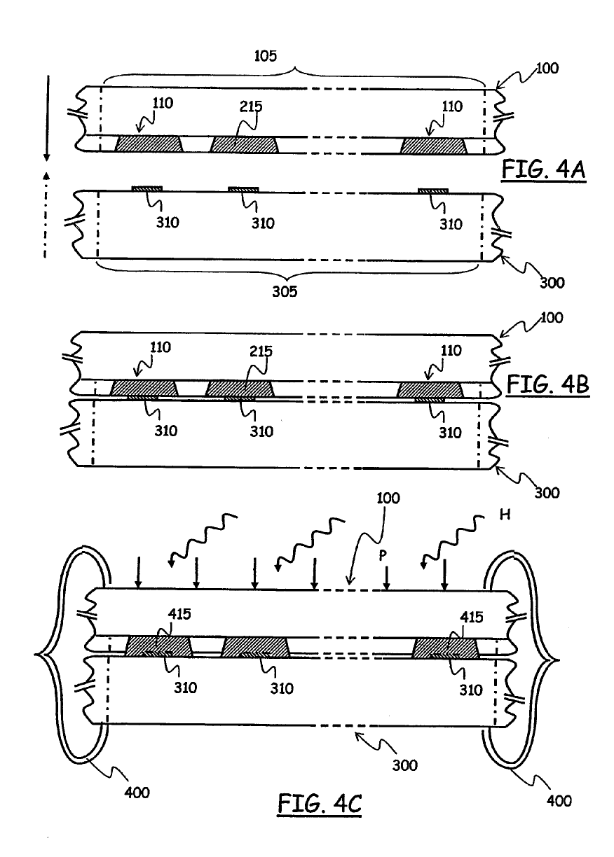

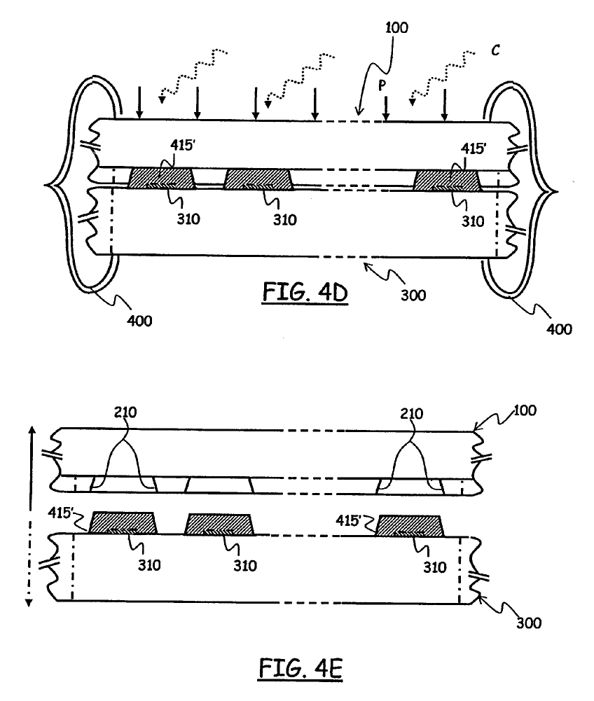

A decal solder transfer method according to an embodiment of the present invention is described in the following, making reference to FIGS. 4A to 4E.

Firstly (FIG. 4A) the decal wafer 100 and the target wafer 300 are properly aligned, so that each of the decal wafer portions 1 05 of the decal wafer 100 corresponds to a respective chip 305 of the target wafer 300; in particular, the alignment of the decal wafer 100 to the target wafer 300 is such that each of the solder alloy carrying areas 110 of the former faces the respective interconnection pad 310 on the target wafer 300. It is observed that the mutual alignment of the decal wafer 100 and of the target wafer 300 can be achieved exploiting the same instruments and techniques exploited for aligning photolithographic masks to the wafer 300 during the manufacturing of the IC and/or MEMS chips 305: in this respect, the decal wafer 100 can be regarded as one of such masks.

The two wafers 100 and 300 are brought close to each other preserving the alignment, so that each solder alloy carrying area 110 abuts against the exposed surface of the respective interconnection pad 310 (FIG. 4B).

The two wafers 100 and 300, while kept in the above-described sandwich arrangement, are then exposed to heat H, as schematically shown in FIG. 4C. This can be accomplished for example by using a suitable heater, or by introducing the wafer sandwich into an in-line oven, or, in case the decal wafer 100 is made of a material transparent to light, for example silicon (silicon is transparent to Infra-Red (IR) light from 1.1 to 2.5 microns), by selective irradiation of a light, e.g. an IR light source like a laser, that will selectively heat and melt the small solder alloy masses. The temperature rise shall be sufficient to cause the solder alloy masses 215 present in the pockets 210 reflow or reliquify; reflown or reliquified solder alloy masses 415 thus wet the interconnection pads 310 on the wafer 300.

According to an embodiment of the present invention, the reflowing or reliquifying of the solder alloy masses 215 is performed while ensuring that the decal wafer exerts a sufficient pressure P against the wafer 300 (or, equivalently, that the target wafer 300 is kept pressed against the decal wafer 100), for example by using mechanical clamps, e.g. elastic clamps, schematically depicted in the drawings and identified by 400; more generally, the reflow or reliquifying of the solder alloy masses 215 is performed while ensuring that the two wafers 100 and 300 are kept in close contact one to the other. As a result, it is ensured that, during the reflow or reliquifying of the solder alloy masses 215, the decal wafer 100 is kept in close contact with the surface of the wafer 300 and does not lift there from; in this way, no leakages of liquified solder alloy take place, and the solder alloy masses, even if in the liquid phase, substantially retains the shape of the pockets 210 wherein they were originally contained.

It is observed that in case the solder masses 215 on the decal wafer 100 are formed by means of the above-mentioned IMS technique, the solder alloy masses 215, after deposition, undergo solidification and, consequently, volume reduction; the exposed surface of the solidified solder alloy deposits is thus not perfectly flush with the surface of the decal wafer 100, and is instead slightly recessed there from, a small, micrometric gap (not shown in the drawings for the sake of clarity) existing between the exposed surface of the solidified solder alloy deposits 215 and the surface of the decal wafer. As a consequence, when the decal wafer 100 is firstly laid on the target wafer 300, a micro-gap may exist between the exposed surface of the solidified solder alloy deposits and the surface of the pads 310 to be wetted. The extent of such a reduction in volume of the solder alloy masses 215 due to the solder alloy solidification is equal to the volume expansion of the solder deposits when they are subjected to a further, subsequent reflow. In this secondary reflow, the expansion of the solder alloy bridges the micro-gap between the exposed surface of the solidified solder alloy masses 215 and the pads 310 on the target wafer 300, starting the wetting process between the alloy and the pad; such a process can be enhanced with the utilization of oxide-removal agents also known as soldering fluxes.

It is observed that, in principle, the pressure P might originate from the very weight of the decal wafer 100 (or from the weight of the target wafer 300); however, the Applicant has observed that the material used to form the decal wafer 100 is typically such that the decal wafer 100 has a weight not sufficient to ensure that, during the reflow or reliquifying of the solder alloy masses 215, the latter causes the decal wafer 100 to lift from the surface of the wafer 300. This is more evident when, on the same decal wafer, there are several thousands of solder masses to be transfered onto the target wafer; by way of example, a 15×15 mm silicon chip can have more than five thousand solder contacts at a 200 μm pitch, and half a million solder contacts can be present in a 200 mm wafer. The combined solder alloy surface tension and differential wafers cooling rate can alter the parallelism between the two wafers, leading to irregular transferred solder alloy masses with uneven heights. For the aforementioned reasons, ensuring that the two wafers are kept at least slightly pressed one onto the other, for example by clamping the two wafers together, or in any other way, allows guaranteeing uniform topological characteristics of the transferred alloy blocks. It is observed that the pressure P to be exerted depends on several parameters, including, but not limited to, the spatial configuration of the solder alloy pattern, the number of solder deposits to be transferred perchip, the number of chips, the area of the decal/target wafers.

It is also observed that, by making the decal wafer 100 of a material having a properly chosen thermal expansion coefficient properly, in particular a thermal expansion coefficient matching as close as possible that of the solder-receiving substrate 300, it is ensured that the inevitable thermal expansion of both the wafers 100 and 300 during the exposure to heat does not significantly alter the geometries of the solder alloy carrying areas 110 (which define the geometries of the area of the solder alloy deposits, i.e. the area of solder alloy transfer on the surface of the target wafer 300). However, the requirement that the two wafers have closely matching thermal expansion coefficients is less stringent when selective heating by light sources of the alloy is made through transparent or semi-transparent decals.

Thereafter, still keeping the decal wafer 100 pressed against the wafer 300, the sandwich arrangement of wafers 100 and 300 is exposed to cold C, as schematically shown in FIG. 4D, or the liquified solder alloy masses 415 are simply allowed to cool down and resolidify, so as to form resolidified solder alloy masses 415′ at the pads 310.

Finally, referring to FIG. 4E, the decal wafer 100 is lifted or separated away from the wafer 300; since the solder alloy has no metallurgical affinity with the material of the decal wafer 100, the resolidified solder alloy masses 415′ remain attached to the surface of the wafer 300, in positions corresponding to those of the interconnection pads 310.

It is observed that the resolidified solder alloy masses 415′ that remain attached to the surface of the wafer 300 have a relatively precisely defined shape, and an essentially flat exposed surface; this is achieved thanks to the fact that the reflow/reliquifying, and following cooling down of the solder alloy masses 215 are performed while ensuring that the decal wafer 100 is kept in close contact with the surface of the wafer 300; the resolidified solder alloy masses 415′ thus preserve a shape that closely corresponds to the shape of the pockets 210, because the lateral walls of the pockets 210 retain the reflowed/reliquified solder alloy from leaking out. The shape of the pockets 210 is relatively easily controlled using, for example, conventional photolithographic techniques. In particular, the resolidified solder alloy masses 415′ preserve the essentially flat surface that corresponds to the essentially flat bottom of the pockets 210.

In other words, because the reflow/reliquifying and the subsequent resolidification of the solder alloy is carried out keeping the decal solder transfer substrate and the receiving substrate in a “sandwiched” condition, the decal wafer 100 itself behaves as a flattening element for the solder alloy deposits on the wafer 300, ensuring that the exposed surface of the transferred alloy masses is essentially flat.

The solder alloy masses 415′ transferred onto the wafer 300 can be used for bonding the chips 305 (after mutual separation by scribing) to, e.g., leads of a lead frame of a package (not shown) wherein the chips are to be embedded, or for soldering the chips 305 to other chips, in a stacked-chip arrangement. Such a technique allows for example the stacking of multiple, relatively small semiconductor chips, e.g. silicon device chips, onto a larger semiconductor (e.g., silicon) substrate wherein active and/or passive devices are for example integrated (the substrate may be a purely electrical/electronic IC, a purely mechanical device, integrating only mechanical components and without electrical/electronic components integrated therein, or a mix) thus creating for example a Silicon-on-Silicon (SoS) or Silicon-on-Glass (in the case of glass large substrate) system, forming a multi-chip module configuration. SoS or SoG systems may include MEMS or MOEMS portions. The bonding operation can be performed either after separating the chips 305, or before, in which case it is carried out as a wafer scale assembly operation.

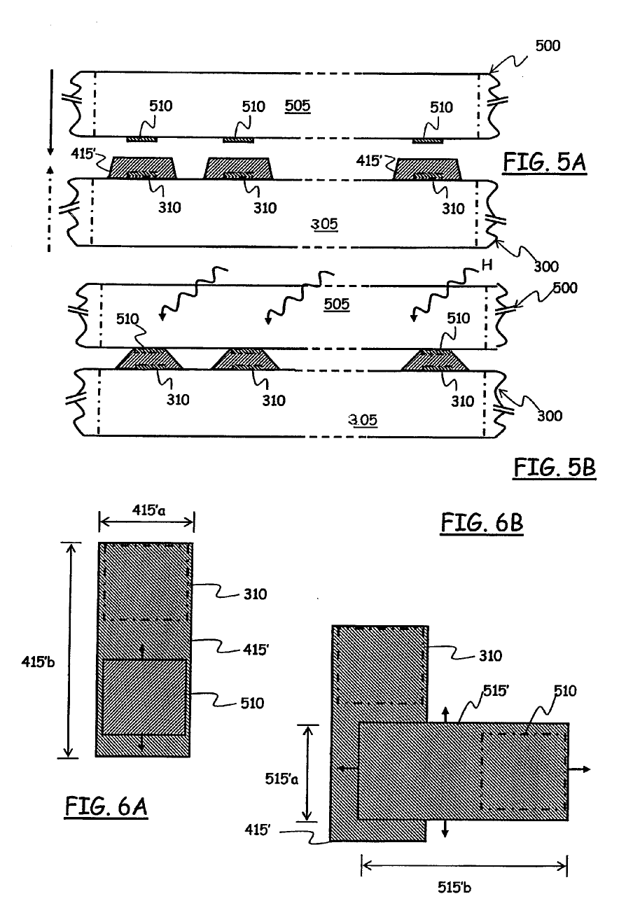

FIGS. 5A and 5B shows, in schematic cross-sectional views similar to those of the preceding drawings, two phases of a process of stacking and bonding two chips, particularly one of the above-mentioned chips 305, on which the solder alloy masses 415′ have in advance been transferred in the way described in the foregoing, and another chip 505; in particular, it is assumed that the stacking and bonding are performed before separating the chips of the wafers, so that the chips 305 still form part of the wafer 300, while the chips 505 to be stacked and bonded thereto are part of another wafer 500. It is pointed out that this is not to be construed limitatively for the present invention.

By way of example, the chips 305 may carry MEMS/MOEMS structures, such as micromotors, while the chips 505 may be CMOS IC chips with the circuitry for controlling the MEMS/MOEMS structures.

The chips 505 to be stacked and bonded to the chips 305 are assumed to have, on their exposed surface, interconnection pads 510, in areas where there are to be provided electrical and/or mechanical interconnections. In particular, at least some of the interconnection pads 510 are located in correspondence to the interconnection pads 310 on the chips 305.

As depicted in FIG. 5A, the two wafers 300 and 500 are properly aligned, so that each one of the interconnection pads 51 0 is located in correspondence of a respective interconnection pad 310 on a respective chip 305; as observed in the foregoing, the mutual alignment of the wafers 300 and 500 can be achieved exploiting the same equipment and techniques exploited for aligning photolithographic masks to the wafers 300 and 500, during the respective manufacturing. The two wafers 300 and 500 are brought close to each other preserving the above-mentioned alignment, until the pads 51 0 on the chips 505 of the wafer 500 abut against the (exposed surface of the) solder alloy masses 41 5′ attached to the intended, respective pad 310 of the chips 305.

The stacked-wafer assembly is then submitted to heat H, for example by introducing the assembly into an in-line oven, or by using a suitable heater, or in any other suitable way. The temperature rise shall be sufficient to cause the solder alloy masses 41 5′ to reflow or reliquify, so as to wet the pads 510 on the chips 505 of the wafer 500 (FIG. 5B).

Cooling the solder alloy down by submitting the assembly to cold, or simply letting the solder alloy cool down causes the solder to resolidify, and thus the chips 505 can be firmly bonded to the chips 305.

It can be appreciated that since the solder alloy masses 41 5′ have an essentially flat exposed surface, the process of aligning the pads 510 on the chips 505 to the pads 310 on the chips 305 is greatly simplified; in particular, the essentially flat surface of the solder alloy masses 41 5′ offers a relatively large contact area for the pads 510, so that the alignment tolerances are greatly relaxed. On the contrary, if, as in the decal solder transfer methods known in the art, the solder alloy masses 41 5′ were roughly spherical, the surface offered to the contact with the pads 510 would be significantly reduced (ideally, to a single point in case of a perfect sphere); the tolerances of the alignment process would in this case be much stricter.

In the example of FIGS. 5A and 5B, it has been assumed that the solder alloy has preliminary been transferred onto the pads 310 of the chips 305 of the wafer 300, while no such solder alloy transfer has been performed on the wafer 500. This is not a limitation for the present invention: the wafer 500 might as well be subjected to a solder alloy transfer similar to that carried out in respect of the wafer 300, so as to transfer solder alloy deposits onto the pads 51 0.

It is observed that the pockets 210 may be very shallow, having for example depth in the range of few microns, e.g. approximately 15 μm. By way of example, in the case of MEMS applications, a possible range of depths for the pockets 210 on the decal wafer 100 may be from 3 to 50 μm. It is pointed out that, differently from the known decal solder transfer methods, in the method according to the present invention it is not essential to transfer a significant mass of material.

Concerning the area of the pockets 21 0 provided in the decal wafer 100 for receiving the solder alloy masses 21 5, i.e. their length and width, they may in principle have an area comparable (slightly smaller, equal, slightly larger) to that of the interconnection pads with which they are intended to mate. However, according to a preferred embodiment of the present invention, the area of the pockets 210 is larger, at least in one dimension, e.g. length or width, compared to that of the corresponding pad intended to receive the solder deposit. This allows a further relaxation of the alignment tolerances.

Alignment tolerances can be further relaxed in case a particular layout for the solder alloy masses 41 5′ is adopted, as will be discussed in the following.

In particular, according to a preferred embodiment of the present invention, the solder alloy masses 41 5′ that are transferred from the decal solder alloy carrier to the receiving substrate have a larger size than the receiving pads on the receiving substrate, as in the examples shown in the drawings attached hereto. This is achieved by making the pockets 210 in the decal wafer 100 larger in size than the receiving pads 310. In this way, the solder alloy masses 41 5′ have an increased effective exposed surface available for mating with, e.g., a corresponding pad 51 0 on a chip 500 to be stacked and soldered.

FIGS. 6A and 6B shows two exemplary geometries for the transferred solder alloy masses that are effective in relaxing the placement tolerances of two chips or wafers during a stacking and bonding process; in both the examples that will be discussed, it is assumed that the pads are substantially square in shape, but this is not limitative, similar considerations applying in case of different shapes. In particular, making reference to FIG. 6A, it is assumed that the geometry of the generic pocket 21 0 in the decal wafer 100 is generically rectangular, with a shorter side of length substantially equal to the length of the side of the pads, and a longer side longer than the pad side, for example at least four times longer. Thus, by means of the solder transfer process described in the foregoing, solder alloy masses 41 5′ of generically rectangular shape, with a shorter side 415′a of length substantially equal to that of the receiving pad 310, and a longer side 415′b of length approximately four times longer than the pad side are obtained. Such elongated solder alloy masses 41 5′ greatly enlarge (e.g. widen) the surface offered for placing the pad 510 of a chip 505 to be soldered to the chip 305, the surface available for placing the pad 510 being significantly greater than that of the original pad 310; in particular, with the arrangement of FIG. 6A, the alignment tolerances in the direction of the longer side 415′b of the solder alloy masses 415′ is significantly relaxed.

The arrangement of FIG. 6B allows a further relaxation of the alignment tolerances; by providing solder alloy masses 51 5′ also in correspondence of the pads 510 of the chips 505, and making the geometry of the solder alloy masses 51 5′ similar to that of the solder alloy masses 41 5′ provided on the chips 305, i.e. generically rectangular, with a shorter side 515′a of length substantially equal to the length of the side of the pad 51 0, and a longer side 515′b of length approximately four times longer than the pad side, an additional degree of freedom in the direction of the longer side 515′b of the solder alloy mass 515′ is introduced in the placement of the two chips 305, 505.

Other geometries are possible in addition to the exemplary one just discussed; for example, the solder alloy mass 41 5′ may have the shape of a cross, so that a similar freedom of placement as that described in FIG. 6B can be achieved without the need of transferring solder onto the chip 505.

Alternatively, one of the two chips to be bonded together, for example the second chip 505, may be provided with pads 510 which, instead of being substantially square in shape, are elongated in a direction transversal to the direction along which the solder alloy masses 41 5′ formed on the first chip 305 are elongated. In this way, the solder alloy masses 41 5′ formed on the first chip 305, and the pads 510 on the second chip 505 extend transversally, for example orthogonally to each other. Such a transversal, for example orthogonal placement of solder alloy masses and respective receiving pads substantially improve the self-alignment, self-centering properties of the interconnections, thanks to the inherent surface tension of the reflowed solder alloy: when the pads are wetted by the reflowed solder alloy, the surface tension of the solder alloy tends to automatically align the solder alloy mass and the respective receiving pad, with wider tolerance in true center pad-to-pad positioning. In the case of stacked-chips arrangements, such enhancement in the precision of positioning becomes an enabling factor for multiple devices stacking onto functional substrates (MEMS and MOEMS on SoS and/or SoG).

The method according to the present invention has the advantage that it is thus possible to obtain, on an intended, target substrate, solder alloy deposits that have an essentially flat exposed surface, instead of a rounded, e.g. spherical surface. This greatly simplifies the process of placement of the substrate in a subsequent bonding process, for example the placement of the substrate with solder with respect to another substrate, e.g. another IC and/or MEMS/MOEMS chip, intended to be stacked and bonded thereto. The alignment tolerances are in fact greatly relaxed, thanks to the fact that the solder alloy deposits have an essentially flat surface.

It is observed that such a flat surface is achieved without necessity of hard mechanical processes such as those involving hammering, which would in many cases lead to a destruction of the chips to be bonded together.

In addition, the essentially flat surface of the solder deposits is obtained without the need of performing additional process steps.

All this translates in particular into the possibility of using simpler, less sophisticated (less precise) and thus less expensive chip/wafer placement tools, and at the same time in an increased production yield, consequence of a reduced defectivity of the solder joints.

It is pointed out that the present invention is not limited by the specific shape of the pads onto which the solder alloy has to be transferred: any shape is possible, square, rectangular, generally polygonal, or round/oblong.

The present invention is particularly advantageous whenever structures are to be soldered by means of solder joints having physical dimensions in the micron or even submicron scale, so that it is necessary to transfer carefully controlled, small amounts of solder alloy; this is in particular the case of MEMS/MOEMS chips stacking.

Although the present invention has been disclosed and described by way of some embodiments, it is apparent to those skilled in the art that several modifications to the described embodiments, as well as other embodiments of the present invention are possible without departing from the scope thereof as defined in the appended claims.

For example, it is not strictly necessary that the decal wafer 100, more generally the decal solder alloy carrier has the same size as the target wafer 300, generally the receiving substrate: the decal wafer 100 may for example have a smaller size, and cover only a portion of the target wafer 300, for example an area corresponding to one or more chips 305, and be stepped onto the target wafer 300, similarly to the step-by-step transfer of mask patterns onto wafers in conventional planar technology.

What is claimed is:

1. A method of forming alloy deposits at selected areas on a receiving substrate, comprising:
providing a decal alloy carrier, having alloy loadable areas in selected positions thereof, said alloy loadable areas being adapted to being loaded with an alloy mass;
mating said decal alloy carrier with the receiving substrate, so that said alloy loadable areas substantially correspond to the selected areas on the receiving substrate; and
reflowing the alloy masses so as to cause transfer of the alloy from said alloy loadable areas to the selected areas on the receiving substrate, while ensuring that said decal alloy carrier and the receiving substrate are kept in close contact one to another at least during said reflowing.

2. The method according to claim 1, further comprising resolidification of the alloy after said reflowing, wherein said resolidification of the alloy is performed while ensuring that said decal alloy carrier and the receiving substrate are kept in close contact one to another.

3. The method according to claim 1, in which said decal alloy carrier is comprised of a material that does not metallurgically bond to said alloy.

4. The method according to claim 3, in which said decal alloy carrier is comprised of a material having a thermal expansion coefficient lower than or substantially equal to that of the receiving substrate.

5. The method according to claim 3, in which said decal alloy carrier is comprised of a material transparent to light.

6. The method according to claim 5, in which said reflowing further comprises selective irradiation of light.

7. The method according to claim 1, in which said alloy loadable areas comprise recesses in said decal alloy carrier.

8. The method according to claim 7, in which said recesses have an essentially flat bottom surface.

9. The method according to claim 1, in which said selected areas on the receiving substrate include solder-affine interconnection pads.

10. The method according to claim 1, in which said alloy loadable areas have an area substantially equal to that of the selected areas on the receiving substrate.

11. The method according to claim 1, in which said alloy loadable areas have an area larger than that of the corresponding selected areas on the receiving substrate in at least one dimension.

12. The method according to claim 1, in which said decal alloy carrier comprises a material having a thermal expansion coefficient substantially equal to that of the receiving substrate.

13. The method according to claim 1, in which said decal alloy carrier comprises a material selected from the group consisting of silicon, glass and quartz.

14. The method according to claim 1, wherein said ensuring that said decal alloy carrier and the receiving substrate are kept in close contact one to another comprising applying pressure so that said decal alloy carrier and the receiving substrate remain substantially parallel to one another.

15. The method according to claim 14, further comprising resolidification of the alloy after said reflowing, wherein said resolidification of the alloy is performed while ensuring that said decal alloy carrier and the receiving substrate are kept in close contact one to another by said applying pressure.

16. The method of claim 7 wherein said recesses in said decal alloy carrier are formed by a process selected from the group consisting of photolithography, wet bulk micromachining, dry bulk micromachining and surface micromachining.

17. The method of claim 7 further comprising loading said recesses with alloy by injection molded soldering.

18. A method of interconnecting a first substrate to a second substrate, comprising:
forming transferred alloy deposits at selected areas on the first substrate, and using the transferred alloy deposits, bonding the second substrate to the first substrate at selected areas on the second substrate, said selected areas on the second substrate having metallurgical affinity with the transferred alloy deposits,
wherein said forming transferred alloy deposits comprises:
providing a decal alloy carrier, having alloy loadable areas in selected positions thereof, said alloy loadable areas being adapted to being loaded with an alloy mass;
mating said decal alloy carrier with the first substrate, so that said alloy loadable areas substantially correspond to the selected areas on the first substrate; and
reflowing the alloy masses so as to cause transfer of the alloy from said alloy loadable areas to the selected areas on the first substrate, while ensuring that said decal alloy carrier and the first substrate are kept in close contact one to another at least during said reflowing.

19. The method according to claim 18, further comprising transferring onto the second substrate, at said selected areas thereof, second alloy deposits, said transferring comprising:
providing a decal alloy carrier, having alloy loadable areas in selected positions thereof, said alloy loadable areas being adapted to being loaded with an alloy mass;
mating said decal alloy carrier with the second substrate, so that said alloy loadable areas substantially correspond to the selected areas on the second substrate; and
reflowing the alloy masses so as to cause transfer of the alloy from said alloy loadable areas to the selected areas on the second substrate, while ensuring that said decal alloy carrier and the second substrate are kept in close contact one to another at least during said reflowing.

20. The method according to claim 18, in which said selected areas on the first substrate are elongated in a first direction, and said selected areas on the second substrate are elongated in a second direction transversal to the first direction.
